(19) United States
(12) Patent Application Publication
(10) Pub. No.: US 2019/0145366 A1
(43) Pub. Date: May 16, 2019

(54) Arrangement of Housing and a Flange

(71) Applicant: Continental Automotive GmbH, Hannover (DE)

(72) Inventors: Eyk Heinemann, Cham (DE); Jörg Bernhardt, Nürnberg (DE); Yavuz Kurt, Roding (DE)

(73) Assignee: Continental Automotive GmbH, Hannover (DE)

(21) Appl. No.: 16/094,372

(22) PCT Filed: Apr. 12, 2017
(86) PCT No.: PCT/EP2017/058853

§ 371 Date: Oct. 17, 2018

(30) Foreign Application Priority Data
Apr. 18, 2016 (DE) 10 2016 206 459.2

(51) Int. Cl. F02M 59/02; F02M 59/48

(52) U.S. Cl. CPC F02M 59/025; F02M 2200/855; F02M 59/48

(57) ABSTRACT

Some embodiments include an assembly comprising: a housing; a flange having a first and second flange side; and a collar extending into a connector opening of the flange. The flange includes a first assembly opening remote from the connector opening. The first assembly opening has a first peripheral portion contiguous with a first flange surface region and a second peripheral portion contiguous to a second flange surface region and closer to the connector opening than the first peripheral portion. A periphery of the connector opening on the second flange side and/or a surface region of the flange adjacent to the connector opening defines a geometric reference plane. The first flange surface region is more remote in comparison to the second flange surface region in a direction perpendicular to the reference plane.

### CROSS-REFERENCE TO RELATED APPLICATIONS

This application is a U.S. National Stage Application of International Application No. PCT/EP2017/058853 filed Apr. 12, 2017, which designates the United States of America, and claims priority to DE Application No. 10 2016 206 459.2 filed Apr. 18, 2016, the contents of which are hereby incorporated by reference in their entirety.

### TECHNICAL FIELD

The present disclosure relates to assemblies of a housing and a flange. Various embodiments may include a high-pressure gasoline or diesel pump.

### BACKGROUND

A housing may include, for example, a housing of a high-pressure gasoline or diesel pump (for example a single-piston pump). Pumps of this type are often assembled on a housing of the cylinder head of an engine, typically by means of two screws. Depending on the operating conditions, the pump can be lifted from the cylinder head during the operation by virtue of the pressure in the piston chamber of the pump in the housing. Said lifting has to be largely minimized or avoided so as to reduce the loadings on the pump components and to avoid a pump failure.

FIG. 26 by means of a sectional view in a schematically simplified manner shows a fragment of a known combination 1′, wherein the (right) portion of the combination 1′ (not shown in FIG. 26) is configured so as to be symmetrical in relation to the line S′. A housing 2′, which is, in the example, the housing of a single-piston pump, on the external side thereof has a collar 6′ which is fixedly inserted in a connector opening 7′ of a flange 3′. The flange 3′, on sides which are mutually opposite in relation to the connector opening 7′, has in each case one continuous assembly opening 8′. A housing which is shown in fragments and which is the cylinder head housing of an engine is indicated with the reference sign 18′, and the combination 1′ that comprises the housing 2′ and the flange 3′ is to be fastened to said housing 18′ by means of two screws 19′.

Proceeding from a planar fastening surface 21′ of the housing 18′, an insertion opening 24′ and two assembly bores 25′, so as to be aligned with the assembly openings 8′, extend into the housing 18′, the housing 2′ in the assembled state protruding into said insertion opening 24′. The surfaces of the flange 3′ on the first flange side 4′ and on the second flange side 5′ that points toward the housing 18′ are continuously planar, the fastening surface 21′ likewise being planar. A collar longitudinal end 16′ projects beyond the flange surface on the second flange side 5′, the former by way of the end face 17′ thereof being supported on the fastening surface 21′, such that in the non-deformed initial state (shown in FIG. 26) in which the screws 19 have not yet been tightened a parallel gap runs between the flange 3′ and the housing 18′, the gap width of said gap being indicated by the dimension b′.

As a result of the flange design embodiment described, a first flange surface region 10′ which is contiguous to a first peripheral portion 9′ of the assembly opening 8′, and a second flange surface region 12′ which lies comparatively closer to the housing 2′ and which is contiguous to a second peripheral portion 11′, extend within a common plane. The housing 2′ can be aligned by way of a bead. In the case of increasing system pressures there is the difficulty that the housing 2′ of the pump can be lifted from the housing 18′ of the engine (so-called “breathing of the pump”). In order for this to be prevented, a pre-tensioning force is required which can be applied by way of the flange 3′ as a resilient element. To this end, the flange 3′ in the non-stressed initial state has the described spacing from the housing 18′, said spacing being able to serve as a pre-tensioning distance (principle of the bending beam). Proceeding from FIG. 26, if the two screws 19′ are tightened, the flange 3′ in the region of the ends thereof is flexed.

However, by virtue of the flexing, an angular error is created at the screw head bearing areas of the flange 3′, said angular error leading to a non-uniform stress on the respective screw head 28′. The screw head 28′ herein quasi has to generate the parallelism between the flange 3′ and the fastening surface 21′ of the housing 18′. Any tilting of the housing 2′ and any axial lifting in operation is to be prevented by means of the axial pre-tensioning achieved by the initially present gap, since said tilting and lifting can be detrimental to kinematic sequences such as, for example, an axial movement of a valve piston or pump piston in the interior of the system to be fastened.

In order for the pre-tensioning to be generated on the flange 3′, the two outer sides of the flange 3′ are pulled down by tightening the two screws 19′, while the flange 3′ in the interior region thereof is fixedly connected to the housing 2′ by way of a circular weld, for example. In the case of the deformation of the flange ends in the screw-fitting direction that results from tightening, an undesirable incline occurs which loads the screw head 28′ in a unilateral non-symmetrical manner. The tensions generated on account thereof can lead to a failure of the screw head 28′ and to the latter being torn off. This risk increases as the flange pre-tensioning increases, and in the case of wide screw heads 28′.

It has been attempted to date to solve this problem by delimiting the pre-tensioning and the tilting of the flange outer sides resulting therefrom, or by using high-strength screws having a smaller screw head bearing area. It has also been attempted to address any undesired unilateral, or non-symmetrical, respectively, introduction of force in that in each case one passage opening has been incorporated in the flange 3′ between the connector opening 7′ and each connector opening 8′, so as to reduce the rigidity of the flange below the more intensively stressed side of the screw head.

### SUMMARY

Against this background, the teachings herein may be used to refine a combination of the type mentioned. Some embodiments may enable the planar distribution of load between flange surface regions, which are contiguous to the periphery of assembly openings and serve as bearing region for a screw head, and a screw head that results in an assembly of the combination by means of screws on a housing to be influenced. In some embodiments, the contact region between a screw head and an assigned flange surface portion that is contiguous to an assembly opening can be influenced in terms of size.

For example, some embodiments may include a combination (1) comprising a housing (2) and a flange (3) which has a first flange side (4) and opposite thereto a second flange side (5), wherein the combination (1) comprises a collar (6) which is either part of the housing (2) or fastened to the housing (2), wherein the collar (6) is inserted in a connector opening (7) of the flange (3), wherein the flange (3) has at least one first assembly opening (8) which is configured so as to have a spacing from the connector opening (7), wherein the at least one assembly opening (8) has in each case one first peripheral portion (9) to which a first flange surface region (10) on the first flange side (4) is contiguous, and in comparison a second peripheral portion (11) which in each case to the first peripheral portion (9) of said assembly opening (8) lies closer to the connector opening (7), to which second peripheral portion (11) a second flange surface region (12) on the first flange side (4) is contiguous, characterized in that on the second flange side (5) a periphery (14) of the connector opening (7), and/or a surface region (15) of the flange (3) that is adjacent, in particular contiguous, to the connector opening (7), define(s) a geometric reference plane (E), and in that the first flange surface region (10) in comparison to the second flange surface region (12) in a direction perpendicular to the reference plane (E) is more remote from the latter.

In some embodiments, the flange (3) has at least one second assembly opening (8) which is configured so as have a spacing from the connector opening (7), wherein the connector opening (7) is configured between the first assembly opening (8) and the second assembly opening (8), in that the second assembly opening (8) has in each case one first peripheral portion (9) to which a first flange surface region (10) on the first flange side (4) is contiguous, and in each case one second peripheral portion (11) that in comparison to the first peripheral portion (9) of said second assembly opening (8) lies closer to the connector opening (7), to which second peripheral portion (11) a second flange surface region (12) on the first flange side (4) is contiguous, and in that the first flange surface region (10) that is contiguous to the first peripheral portion (9) of the second assembly opening (8) in comparison to the second flange surface region (12) that is contiguous to the second peripheral portion (11) of the second assembly opening (8) in a direction perpendicular to the reference plane (E) is more remote from the latter.

In some embodiments, the connector opening (7) in terms of a direction of longitudinal extent (L) of the flange (3) is configured so as to be, in particular centric, between the two assembly openings (8), wherein in particular the respective longitudinal central axes of the connector opening (7) and of the two assembly openings (8) collectively intersect a geometric longitudinal center line (20).

In some embodiments, the collar (6) is inserted in the connector opening (7) such that a collar longitudinal end (16) of the collar (6) on the second flange side (5) in a direction perpendicular to the reference plane (E) projects from the connector opening (7) beyond said reference plane (E).

In some embodiments, the collar (6) is press-fitted into the connector opening (7) and/or is welded to the flange (3), in particular by means of a laser welding method, or is fixedly connected in another way.

In some embodiments, the quantitative difference, in particular the largest quantitative difference that arises, between the spacing of the first flange surface region (10) from the reference plane (E) in a direction perpendicular to the latter, on the one hand, and the spacing of the second flange surface region (12) from the reference plane (E) in a direction perpendicular to the latter, on the other hand, is smaller than or equal to the spacing of an end face (17) of the collar longitudinal end (16) and the reference plane (E) in a direction perpendicular to the latter.

In some embodiments, the housing (18) is a housing (18) of a single-piston pump which in particular is a high-pressure fuel pump, or a housing (18) of a servo valve.

In some embodiments, the first flange surface region (10) and the second flange surface region (12) extend so as to be parallel with the geometric reference plane (E).

In some embodiments, the second flange surface region (12) is a base face of an in particular quadrangular-bordered depression (22) which is configured in the flange (3) on the first flange side (4), in particular is embossed or milled therein.

In some embodiments, the first flange surface region (10) extends so as to be parallel with or inclined to the geometric reference plane (E), and in that the second flange surface region (12), in particular configured so as to be planar or curved, extends so as to be inclined to the geometric reference plane (E), wherein the spacing of the second flange surface region (12) from the reference plane (E) in a direction perpendicular to the latter, when viewed in a direction parallel with the direction of longitudinal extent (L), decreases as the spacing from the connector opening (7) decreases, wherein in particular a peripheral portion (31) of an outer periphery of the second flange surface region (12) runs along a circular line.

In some embodiments, the surface of the flange (3) on the second flange side (5), at least between the connector opening (7) and the assembly opening (8) or the assembly openings (8), extends so as to be parallel with the reference plane (E).

In some embodiments, the first flange surface region (10) and the second flange surface region (12) are component parts of a planar first flange surface portion that is oriented so as to be inclined in relation the geometric reference plane (E), and in particular in that on the second flange side (5) a second flange surface portion (32) that is contiguous to the same assembly opening (8) and in particular surrounds the latter extends so as to be parallel with or substantially parallel with the first flange surface portion (31).

In some embodiments, the first flange surface region (10) and the second flange surface region (12) are component parts of a first flange surface portion (31) that is curved in a concave manner, the local inclination of said first flange surface portion (31) relative to the reference plane (E) when viewed in a direction that is parallel with the direction of longitudinal extent (L) increasing as the spacing from the connector opening (7) increases, and in particular in that on the second flange side (5) a second flange surface portion (32) that is contiguous to the same assembly opening (8) and in particular surrounds the latter extends so as to be parallel with or substantially parallel with the first flange surface portion (31).

In some embodiments, in each case one clearance (30) is configured in the flange (3) between the connector opening (7) and in each case one assembly opening (8).

In some embodiments, the assembly (1) comprises a housing (18), in particular a cylinder head housing of an engine, which has an in particular planar fastening surface (21) for fastening the combination (1), wherein, proceeding from the fastening surface (21), an insertion opening (24) and at least one first assembly bore (25) extend into the housing (18), wherein the collar longitudinal end (16) is supported on a region of the fastening surface (21) that is adjacent to the insertion opening (24), wherein a screw (19) is guided through the first assembly opening (8) and the first assembly bore (25), wherein the flange (3) is screw-fitted to the housing (18) by means of the screw (19), and wherein the screw (19) is tightened such that a first flange region (26) in which the first assembly opening (8) is configured contacts the fastening surface (21) and in particular is compressed against the latter.

In some embodiments, proceeding from the fastening surface (21), at least one second assembly bore (25) extends into the housing (18), in that a second screw (19) is guided through the second assembly opening (8) and the second assembly bore (25), wherein the flange (3) is screw-fitted to the housing (18) by means of the second screw (19), is wherein the second screw (19) is tightened such that a second flange region (26) in which the second assembly opening (8) is configured contacts the fastening surface (21) and in particular is compressed against the latter.

In some embodiments, the screws (19) have in each case one screw head, the respective bearing region (29) of the latter with the flange (3) lying completely in a respective surface region of the flange (3) that is formed collectively by a first flange surface region (10) and a second flange surface region (12).

In some embodiments, the housing (18) protrudes into the insertion opening (24).

### BRIEF DESCRIPTION OF THE DRAWINGS

The teachings herein are described in more detail hereunder with reference to the appended figures which show exemplary embodiments. In the drawings:

FIG. 1 in a perspective manner shows a combination incorporating teachings of the present disclosure in conjunction with two screws serving for the assembly;

FIG. 2 shows a plan view of the combination shown in FIG. 1, in the viewing direction II;

FIG. 3 shows a sectional view along the section plane III-III from FIG. 2, however in a state assembled on a housing shown in fragments, prior to the screws being tightened;

FIG. 3a shows an enlarged fragment of detail IIIa from FIG. 3;

FIG. 3b shows an enlarged fragment corresponding to FIG. 3a, however after the screw shown has been tightened;

FIG. 4 shows an exploded view of the assembly shown in FIG. 1;

FIG. 5 shows a plan view of the flange of the combination shown in FIGS. 1 to 4;

FIG. 6 shows a sectional view along the section line VI-VI in FIG. 5;

FIG. 6a shows an enlarged fragment of detail VIa from FIG. 6;

FIG. 7 shows a plan view comparable to FIG. 5 of a flange of a combination incorporating teachings of the present disclosure;

FIG. 8 shows a sectional view along the section line VIII-VIII from FIG. 7;

FIG. 8a shows an enlarged fragment of detail VIIIa from FIG. 8;

FIG. 9 shows a partial sectional lateral view of a combination incorporating teachings of the present disclosure, said combination being assembled on a housing, prior to the screws being tightened;

FIG. 9a shows an enlarged fragment of detail IXa from FIG. 9;

FIG. 10 in a perspective manner shows a combination incorporating teachings of the present disclosure, in conjunction with two screws serving for the assembly;

FIG. 11 shows a plan view of the combination shown in FIG. 10, in the viewing direction XI;

FIG. 12 shows a sectional view along the section plane XII-XII from FIG. 11, however in a state assembled on a housing shown in fragments, prior to the screws being tightened;

FIG. 12a shows an enlarged fragment of detail XIIa from FIG. 12;

FIG. 12b shows an enlarged fragment corresponding to FIG. 12a, however after the screw shown has been tightened;

FIG. 13 shows an exploded view of the assembly shown in FIG. 10;

FIG. 14 shows a plan view of the flange of the combination shown in FIGS. 10 to 13;

FIG. 15 shows a sectional view along the section line XV-XV in FIG. 14;

FIG. 15a shows an enlarged fragment of detail XVa from FIG. 15;

FIG. 16 shows a plan view of a flange of a combination incorporating teachings of the present disclosure;

FIG. 17 shows a sectional view along the section line XVII-XVII according to FIG. 16; FIG. 17a shows an enlarged fragment of detail XVIIa from FIG. 17;

FIG. 18 shows a plan view of a flange of a combination incorporating teachings of the present disclosure;

FIG. 19 shows a sectional view along the section line XIX-XIX of FIG. 18;

FIG. 19a shows an enlarged fragment of detail XIXa from FIG. 19;

FIG. 20 shows a plan view of a flange of a combination incorporating teachings of the present disclosure;

FIG. 21 shows a sectional view along the section line XXI-XXI according to FIG. 20;

FIG. 21a shows an enlarged fragment of detail XXIa from FIG. 21;

FIG. 22 shows a partial sectional view through a combination incorporating teachings of the present disclosure, said combination being placed on a housing, prior to a screw being tightened;

FIG. 23 shows the situation shown in FIG. 22, however after the screw has been tightened;

FIG. 24 shows a partial sectional view through a combination incorporating teachings of the present disclosure, said combination being placed on a housing, and prior to the screw shown being tightened;

FIG. 25 shows the situation shown in FIG. 24, however after the screw shown has been tightened; and

FIG. 26 shows a combination known from the prior art, after being placed on a housing, prior to the screw shown being tightened.

### DETAILED DESCRIPTION

In some embodiments, on the second flange side a periphery of the connector opening, and/or a surface region of the flange that is adjacent, in particular contiguous, to the connector opening, defines a geometric reference plane, and the first flange surface region in comparison to the second flange surface region in a direction perpendicular to the reference plane is more remote from the latter. This relates to an initial state of the combination. This is understood in particular to be a state in which the combination is free of external forces that lead to the deformation of said combination. Such a state is present, for example, before the combination is assembled on another object such as, for example, on a housing of an engine.

The housing and the flange can be two components, for example. The flange can be produced from sheet metal, for example. In some embodiments, the housing and the flange can be configured so as to be integral, thus as a common component. In some embodiments, the first flange surface region and the second flange surface region are mutually separated only by a step or an edge or an imaginary border line; this is however not necessary. Such a step or edge or imaginary border line is not a component part of said flange surface regions. For example, face part-regions of faces that lie on different sides of a step or edge or imaginary border line can also be considered as a first flange surface region and as a second flange surface region.

In some embodiments, the angular error that arises in the flexing of the flange in the assembly in relation to the screw head bearing surface already in the non-stressed flange a desired, maybe parallel, screw head bearing is created in the assembled state. This can be achieved by various constructive measures. In this context, numerous possibilities are provided.

In some embodiments, the connector opening and the assembly openings extend as passage openings through the flange. In that case two or a larger number of assembly openings having in each case first and second flange surface regions that are contiguous to said assembly openings are present, said assembly openings can be disposed in different flange regions which extend so as to be adjacent to different sides of the connector opening. In some embodiments, the connector opening can thus be located between flange regions having a respective assembly opening, to near an ideally uniform pre-tensioning force in the contact zone in the assembly of the combination on a housing (for example, on an engine housing).

In some embodiments, the flange has two assembly openings, wherein the connector opening in terms of a direction of longitudinal extent of the flange may be centered between the two assembly openings and wherein the respective longitudinal central axes of the connector opening and of the two assembly openings may collectively intersect a geometric longitudinal center line. In some embodiments, the flange may have an elongate contour along the direction of longitudinal extent, wherein in each case one of the assembly openings having in each case first and second flange surface regions contiguous to said assembly openings are configured in the region of in each case one of the two longitudinal ends of the flange.

In some embodiments, the collar may be inserted in the connector opening such that a collar longitudinal end of the collar on the second flange side in a direction perpendicular to the reference plane projects from the connector opening beyond said reference plane. An end face of the collar longitudinal end can be configured as a circular face and can have the function of supporting the collar on a housing (for example an engine housing) to which the combination is to be attached by means of screws. To this extent, the latter can be referred to as a circular support face, or functional face, respectively. In the initial state for the flange surface on the second flange side and a fastening surface of the further housing (for example the engine housing) that faces the flange may be so as to be planar, and for the end face of the collar longitudinal end to be axially supported on the fastening surface. In this way, an offset or a gap having a uniform gap width, respectively, can be generated between the flange and the housing specified for assembly, said offset or gap making available a pre-tensioning distance for the flexing of the flange regions and thus for generating the desired pre-tensioning force when screws guided through the assembly openings are tightened.

In some embodiments, the collar is press-fitted in the connector opening and/or is welded to the flange, in particular by means of a laser welding method, or is fixedly connected in another way.

In some embodiments, the flange can have one, two or more assembly openings. In as far as two or more assembly openings are configured, the following explanations relating to a first and a second flange surface region, in as far as this is relevant, refer at least to one first flange surface region that is contiguous to one of said assembly openings, and to a second flange surface region that is contiguous to the same assembly opening. However, when the flange has two assembly openings an individual or a plurality of these features may be implemented in the case of the flange surface regions that are contiguous to the one assembly opening, on the one hand, and also in the case of the flange surface regions that are contiguous to the other assembly opening, on the other hand. This, however, is not necessary, that is to say that there is the possibility for features for an embodiment to be implemented only on a first and only on a second flange surface region.

In some embodiments, the housing of the combination is a housing of a single-piston pump, the latter being in particular a high-pressure fuel pump, for example for gasoline or diesel fuel, or a housing of a servo valve.

In some embodiments, the quantitative difference, in particular the largest quantitative difference that arises, between the spacing of the first flange surface region from the reference plane in a direction perpendicular to the latter, on the one hand, and the spacing of the second flange surface region from the reference plane in a direction perpendicular to the latter, on the other hand, to be smaller than or equal to the spacing of an end face of the collar longitudinal end and the reference plane in a direction perpendicular to the latter. This offers advantages with a view to a desired distribution of the screw clamping force within the contact zone of the latter with the flange.

In some embodiments, the first flange surface region and the second flange surface region extend so as to be parallel with the geometric reference plane. In some embodiments, the first flange surface region and the second flange surface region to be mutually contiguous on a step that is perpendicular to the planes of extent of said two flange surface regions. To this extent, this can be referred to as a quadrangular depression in terms of the second flange surface region. In some embodiments, the second flange surface region to be a base face of an in particular rectangularbordered depression which is configured in the flange on the first flange side, in particular is embossed or milled therein. For example, there is the possibility for the difference in the height level between the first and the second flange surface region to be in a quantitative range from 0.05 mm to 0.2 mm, or to be 0.1 mm.

However, it is understood that differences in the height level that deviate therefrom are possible, depending on the requirements. Said depression can be configured as a pocket in the flange surface. It is understood that the border is not necessarily configured so as to be quadrangular or rectangular, but that other border shapes are also possible.

In some embodiments, the first flange surface region may extend so as to be parallel with or inclined to the geometric reference plane, and for the second flange surface region, in particular configured so as to be planar or curved, to extend to as to be inclined to the geometric reference plane, wherein the spacing of the second flange surface region from the reference plane in a direction perpendicular to the latter, when viewed in a direction parallel with the direction of longitudinal extent, decreases as the spacing from the connector opening decreases.

In some embodiments, a peripheral portion of an outer periphery of the second flange surface region runs along a circular line. In this context, reference can be made to an angular spot-facing of the screw bearing face. Like the previously described depression, the latter also enables an excessive clamping force on only one side of the screw head (in particular on that side of the screw head that lies closer to the connector opening) to be reduced or prevented. The second flange surface region herein can be generated by incorporating a, for example circular or crescent-shaped, or for example rectangular, depression/pocket having an inclined base in the surface of the flange. There are no restrictions in terms of the shape of the border.

The contact of a screw head can be set in a targeted manner to an optimal region by means of the graded difference in the height level described as well as by means of the inclination described, and any unilateral overloading on the screw head can be prevented. Any unilateral contact between the screw head and the flange can be completely prevented if required. However, on the other hand, the contact can be limited to a specific desired geometric region on the lower side of the screw head, depending on the requirements. There is thus the possibility for the loading of a screw to be set in an optimal manner.

In some embodiments, the loading of the screw head for the assembly of the combination on the housing, for example of an engine, in which assembly the flange of the combination is pre-tensioned as a result of the flexing of the flange, as described above. This enables the use of more cost-effective screws of lower strength ratings. This also enables an increase in the pre-tensioning of the flange of the combination (thus of a so-called pump flange, for example). In the past a homogenization of the screw head loading has been attempted in that in each case one clearance that continues through the flange has been configured between the connector opening and in each case one assembly opening. However, this also led to an undesired reduction in the flange rigidity.

In some embodiments, the flange rigidity is influenced to a significantly lesser extent, said flange rigidity being relevant to the pre-tensioning force of the construction. A flange surface region that is inclined in relation to the reference plane can be incorporated in a cost-effective manner, for example by means of a downstream embossing process, or by means of another, for example subtractive, method. When the so-called second flange surface region runs so as to be inclined at an angle in relation to the geometric reference plane, the maximum depth within the oblique depression thus formed in terms of the level of the first flange surface region can be, for example, 0.1 mm; values that deviate therefrom are also possible, depending on the requirements.

In some embodiments, the first flange surface region and the second flange surface region are component parts of a planar first flange surface portion that is oriented so as to be inclined in relation to the geometric reference plane. There is the possibility for on the second flange side a second flange surface portion that is contiguous to the same assembly opening and in particular surrounds the latter to extend so as to be parallel or substantially parallel with the first flange surface portion. In this context, an angled position of the screw head bearing surfaces in the flange so as to correspond to the angle of the flexing of the flange that results when the screws are tightened is preferable.

In some embodiments, the first flange surface region and the second flange surface region to be component parts of a first flange surface portion that is curved in a concave manner, the local inclination of said first flange surface portion relative to the reference plane when viewed in a direction that is parallel with the direction of longitudinal extent increasing as the spacing from the connector opening increases, and in particular for on the second flange side a second flange surface portion that is contiguous to the same assembly opening and in particular surrounds the latter to extend so as to be parallel with or substantially parallel with the first flange surface portion. To this extent, the second flange side (that is to say that flange side that points toward the housing specified for assembly, for example the engine housing) can run in a convex manner corresponding to the flexing line of the flange when the screws are tightened. In order for a desired distribution, in particular homogenization, of the screw tensioning force in the region of the lower side of the screw head to be achieved, an approximation of the flexing line can be performed by means of a plurality of angles or radii.

In some embodiments, in the case of inclined flange surface portions as well as in the case of curved flange surface portions, an approximately parallel screw head bearing in relation to a fastening surface of the (engine) housing results in the pre-tensioned state of the flange. In some embodiments, the flange can either be a dedicated component or alternatively be integrated directly in the housing, for example be forged or molded thereto. The flange can be welded to the housing, for example, or else as a pure pre-tensioning element bear on a bead on the housing, for example. In some embodiments, a lower loading (torsional loading) of the screw heads results by way of a resultant plan-parallel bearing of the screw heads in the pre-tensioned state. In some embodiments, the flexing line of the flange may be modified from an S-shaped profile (similar to a support that is clamped twice) to a flexing line similar to a cantilevered support. This enables the free flexing length to be increased, stresses in the flange to be reduced, and the transition from tensile to compressive stresses within the flange to be reduced. In some embodiments, in each case one clearance to be configured in the flange between the connector opening and in each case one assembly opening.

In some embodiments, there is an assembly which in addition to a combination which has individual or a plurality of the features described above comprises a housing, e.g. a cylinder head housing of an engine. In some embodiments, there is a planar fastening surface for fastening the combination, wherein, proceeding from the fastening surface, an insertion opening and at least one first assembly bore extend into the housing, wherein the collar longitudinal end is supported on a region of the fastening surface that is adjacent to the insertion opening, wherein a screw is guided through the first assembly opening and the first assembly bore, wherein the flange is screw-fitted to the housing by means of the screw, and wherein the screw is tightened such that a first flange region in which the first assembly opening is configured contacts the fastening surface and in particular is compressed against the latter. I

In some embodiments, proceeding from the fastening surface, at least one second assembly bore extends into the housing, a second screw to be guided through the second assembly opening and the second assembly bore, wherein the flange is screw-fitted to the housing by means of the second screw, and wherein the second screw is tightened such that a second flange region in which the second assembly opening is configured contacts the fastening surface and in particular is compressed against the latter. In some embodiments, the screws may have in each case one screw head, the respective bearing region of the latter with the flange lying completely in a respective surface region of the flange that is formed collectively by a first flange surface region and a second flange surface region. In some embodiments, the housing may protrude into the insertion opening.

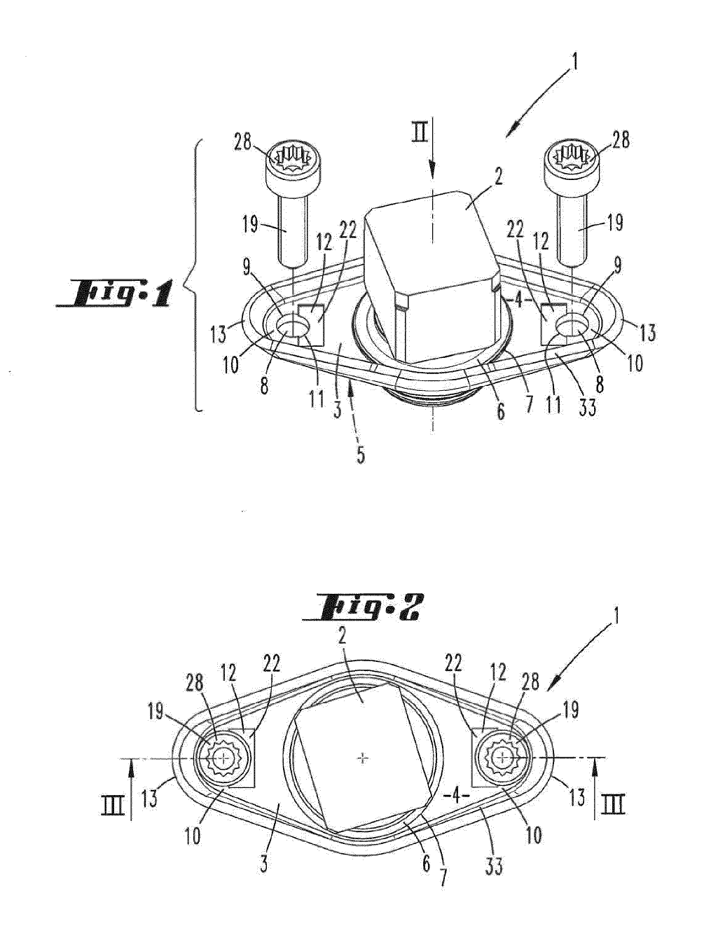

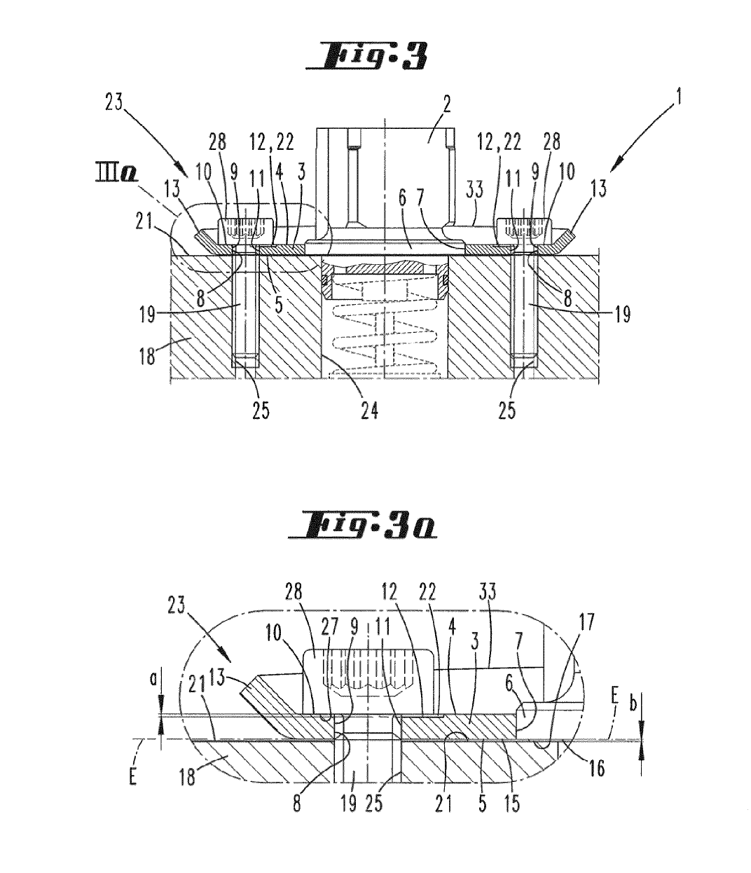

A first exemplary embodiment of a combination 1 according to the invention is presented with reference to FIGS. 1 to 6a. Said combination 1 comprises a housing 2 of a high-pressure fuel pump and a flange 3 which has a first flange side 4 that faces the housing 2 and opposite thereto a second flange side 5. A collar 6 which is inserted in a connector opening 7 of the flange 3 is configured on the housing 2. The collar 6 in the example is press-fitted into the connector opening 7 by way of a press-fit, and is additionally fastened to the flange 3 by means of a laser-welded connection (not shown in more detail). Two assembly openings 8, the latter like the connector opening 7 being through bores, are configured in the flange 3. The assembly openings 8 as well as details that are contiguous thereto or described in the context therewith, respectively, are referred to by the same reference signs for clarity.

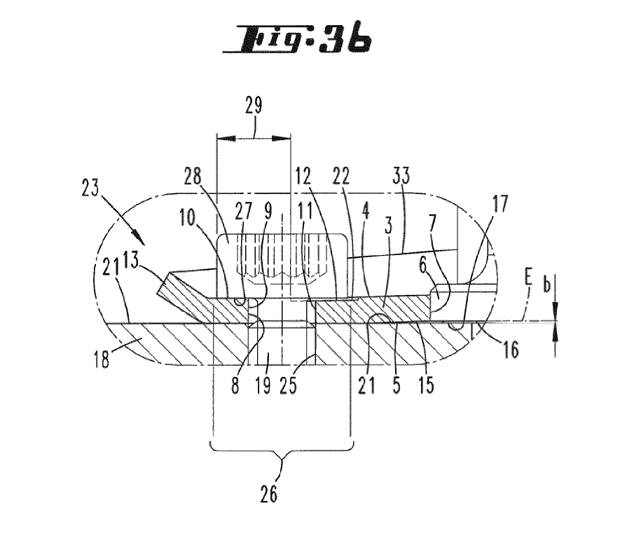

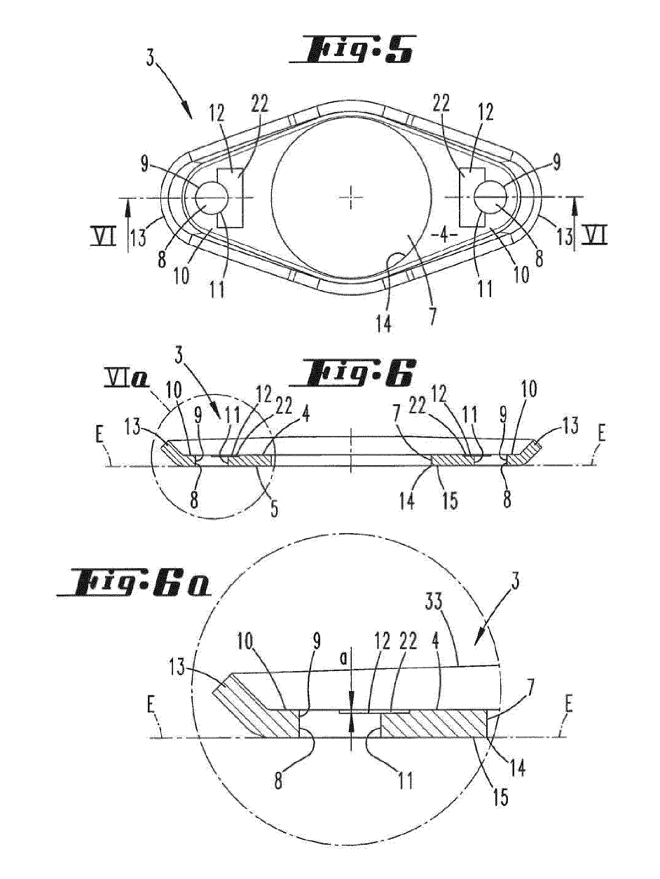

Each assembly opening 8 has in each case one first peripheral portion 9 that faces an adjacent flange longitudinal end 13, a first flange surface region 10 being contiguous to said first peripheral portion 9 on the first flange side 4, and in each case one second peripheral portion 11 that faces the connector opening 7, and thus lies closer to the latter, a second flange surface region 12 being contiguous to said second peripheral portion 11 on the first flange side 4. On the opposite, that is to say the second, flange side 5 (cf. for example FIG. 6, 6a), in the non-stressed initial state, shown for example in FIGS. 3, 3a, a geometric reference plane E that in terms of the lateral extent thereof is non-delimited is defined by a periphery 14 of the connector opening 7 and by a surface region 15 of the flange 3 that is contiguous to the connector opening 7.

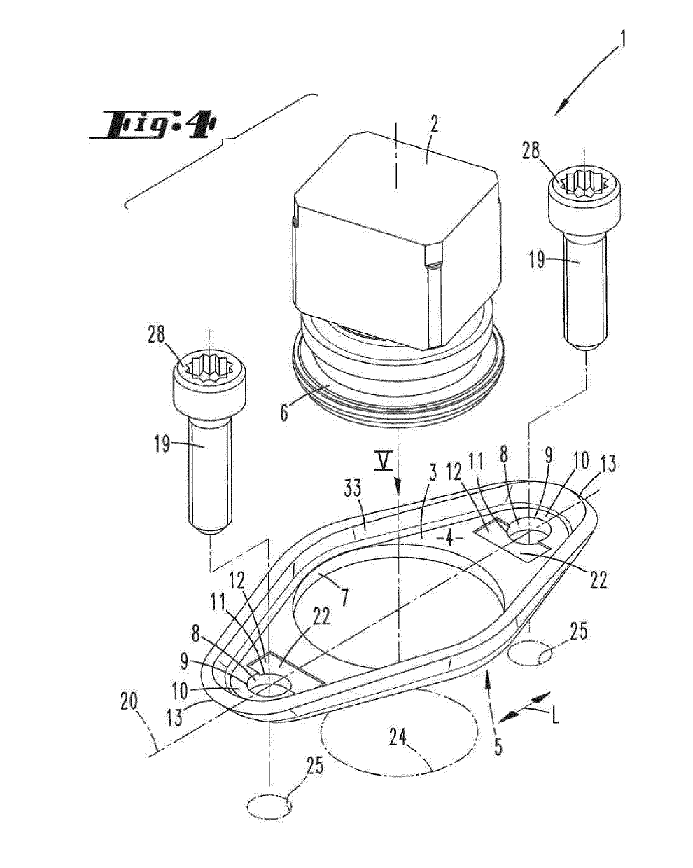

It is illustrated that the first flange surface region 10 in comparison to the second flange surface region 12 in a direction that is perpendicular to the reference plane E is more remote from the latter by a dimension a. The connector opening 7 in terms of a direction of longitudinal extent L of the flange 3 is disposed so as to be centric between the two assembly openings 8, wherein the longitudinal central axes (conjointly indicated in each case in FIG. 4) of the connector opening 7 and of the two assembly openings 8 collectively intersect a geometric longitudinal center line 20.

As is shown in particular in the enlargement of FIG. 3a, the collar in the axial direction is inserted so far in the connector opening 7 that a collar longitudinal end 16 of the collar on the second flange side 5 in a direction perpendicular to the reference plane E projects from the connector opening 7 beyond said reference plane E by a dimension b. FIGS. 3, 3a herein show the combination 1 in conjunction with a fragment of a housing 18 of a cylinder head of an engine, on which housing 18 the combination 1 is to be assembled by means of two screws 19. FIG. 3a shows that the flange 3 in the non-stressed state is configured so as to be planar on the second flange side 5.

In some embodiments, the respective first flange surface region 10 and the respective second flange surface region 12 extend so as to be parallel with the reference plane E. The dimension a (cf. FIG. 3a) is thus uniform for various locations of the two flange surface regions 10, 12 and corresponds to the quantitative difference between the spacing of the first flange surface region 10 from the reference plane E in a direction that is perpendicular to the latter, and the spacing of the second flange surface region 12 from the reference plane E in a direction that is perpendicular to the latter. An end face 17 of the collar longitudinal end 16 in a direction perpendicular to the former is supported on a planar fastening surface 21 of the housing 18 that faces the flange 3.

A spacing or offset, respectively, transverse to the reference plane E between the planar surface region 15 of the flange 3 and the planar fastening surface 21 consequently results from the projecting collar longitudinal end 16, said spacing or offset, respectively, corresponding to the dimension b stated in FIG. 3a. In the example, the second flange surface 12 is a base face of a quadrangular-bordered depression 22 which is embossed in the flange 3 on the first flange side 4. By contrast, the first flange surface region 10 lies on the same height level as the flange surface that surrounds the connector opening 7 on the first flange side 4.

FIGS. 3, 3a show an assembly 23 incorporating teachings of the present disclosure, which in addition to the combination 1 comprises the housing 18 and two screws 19 serving for assembly. Proceeding from the fastening surface 21 of the housing 18, an insertion opening 24 and two assembly bores uniformly referred to with the reference sign 25 extend into the housing 18, the internal thread of said assembly bores 25 matching the external thread of the screws 19.

FIGS. 3, 3a show an incomplete state that arises during the assembly, in which the two screws 19 are in each case guided through one assembly opening and are initially only loosely screwed into an assembly bore 25 aligned with said assembly opening 8, such that the parallel gap (shown enlarged in FIG. 3a) is still maintained, the gap width of said gap corresponding to the dimension b.

FIG. 3b shows the final assembled stated once the screws 19 have been screwed in so tightly that the flange 3 is deformed until a respective flange region 26 in which one of the assembly openings 8 is configured contacts the fastening surface 21 and is compressed against the latter. While FIGS. 3a, 3b show only an enlargement of detail IIIa from FIG. 3, the same situation arises at the second screw fitting. As a result of the deformation of the flange 3 (cf. FIG. 3b), the first and second flange surface regions 10, 12 are oriented so as to no longer be parallel with but inclined to the fastening surface 21.

The stated dimensions a and b in the example are chosen and adapted to the deformation situation such that the lower side 27 of the screw head 28 comes into contact with the flange 3 only in the bearing region 29, wherein the bearing region 29 lies substantially within the first flange surface region 10. On the other side, that is to say the side that faces the housing 2, the lower side 27 of the screw head 28 does not come into contact with the flange 3, or with the second surface region 12 thereon, respectively. In the absence of the depression 22, that is to say if the two flange surface regions 10, 12 in the initial state of the flange shown in FIG. 3a were to lie at the same height level, a consequence of tightening the screw 19 would be that the respective screw head 28, as a result of the deformation of the flange, would be compressed against the flange 3 more intensively on the side that faces the housing 2 than on the side that faces away from the housing 2.

On the other hand, as a consequence of the depression 22 there is now however a reversal of the distribution of stress, as has been described above. It is understood herein that the geometry shown in FIG. 3b is chosen so as to be only exemplary. For example, the dimensions a, b can be varied on demand, such that it can also be achieved, depending on the requirements of the individual case, for example, that the bearing region 29 also extends to that half of the screw head 28 that lies closer to the housing 2. However, in this case the loading at that location in this instance could also be lower than in that half of the screw head that lies closer to the flange longitudinal end 13.

As is shown in FIGS. 1 to 6a, the cross-sectional dimensions of the screw head 18 in the example are adapted to the flange surface regions 10, 12 such that the potential bearing region 29 in any case lies completely within a surface region that is formed collectively by the two flange surface regions 10, 12. The figures also show that the housing 2 in the assembled state protrudes into the insertion opening 24 of the housing 18. In the case of the description hereunder of further exemplary embodiments, for the sake of clarity details which are the same as in the preceding exemplary embodiment or similar thereto are referred to using the same reference signs.

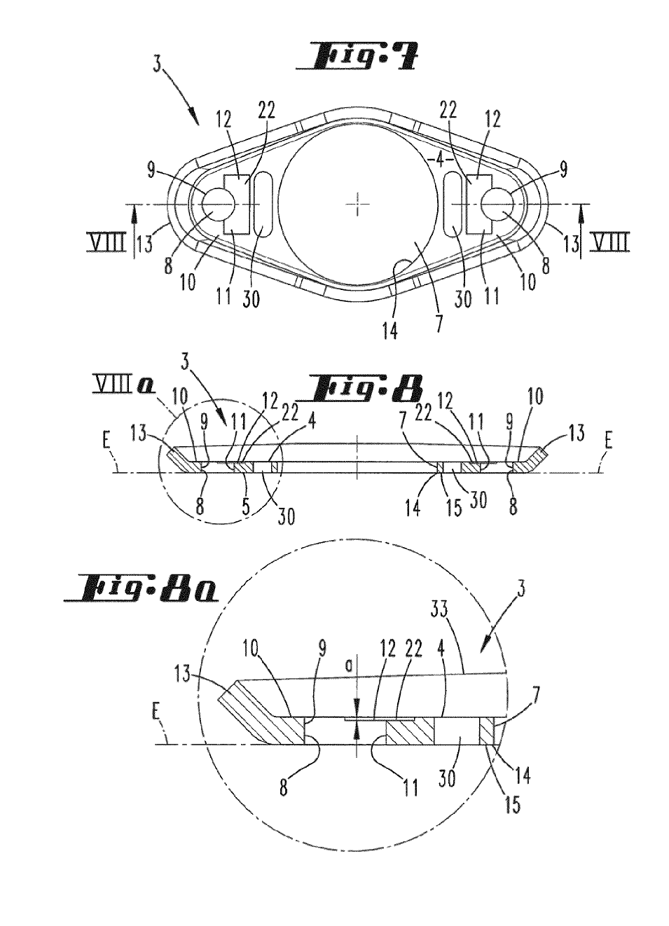

FIGS. 7, 8 and 8a show a design embodiment of a flange 3 for a combination 1 incorporating teachings of the present disclosure, as a potential alternative to FIGS. 1 to 6. The difference lies in that in each case one clearance 30 that continues through the flange 3 is configured between the connector opening 7 and in each case one assembly opening 8. The clearances 30 in turn cause a distribution of the contact pressure.

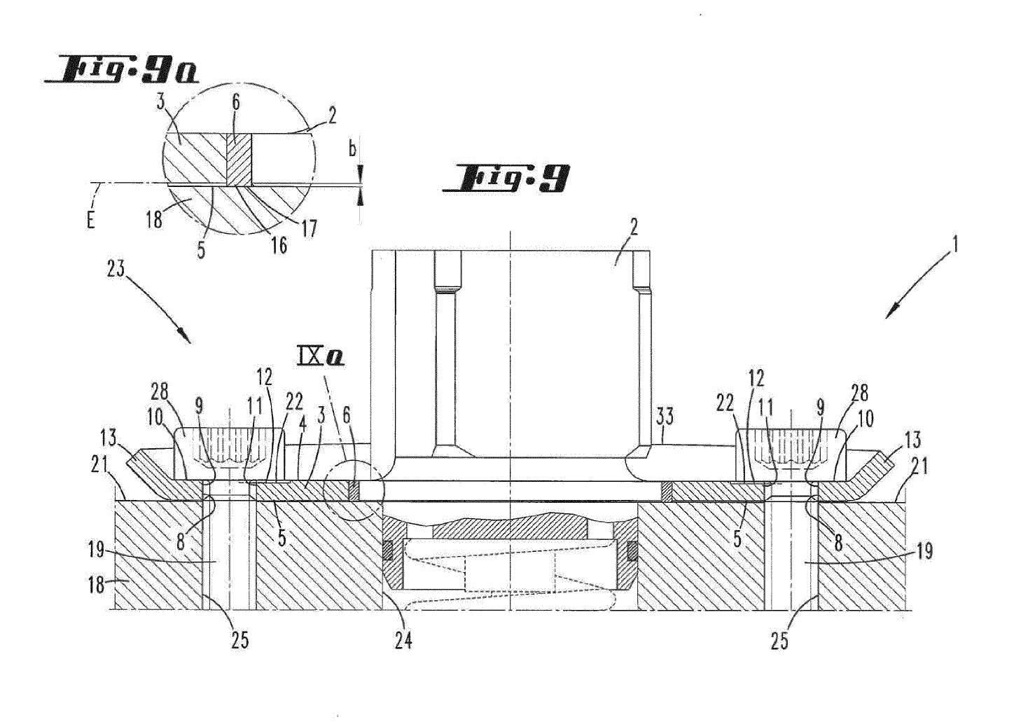

FIG. 9 in a partially sectional lateral view shows an assembly incorporating teachings of the present disclosure, which comprises a combination 1 according to a third exemplary embodiment, a housing 18 that is shown in fragments, and two screws 19 for the assembly. A difference in relation to the preceding exemplary embodiments lies in that the collar 6 and the housing 2 are configured as different components, wherein the collar 6 however is fixedly attached to an external side of the housing 2 in a manner not illustrated in more detail. A welded connection can be considered for the fastening, for example.

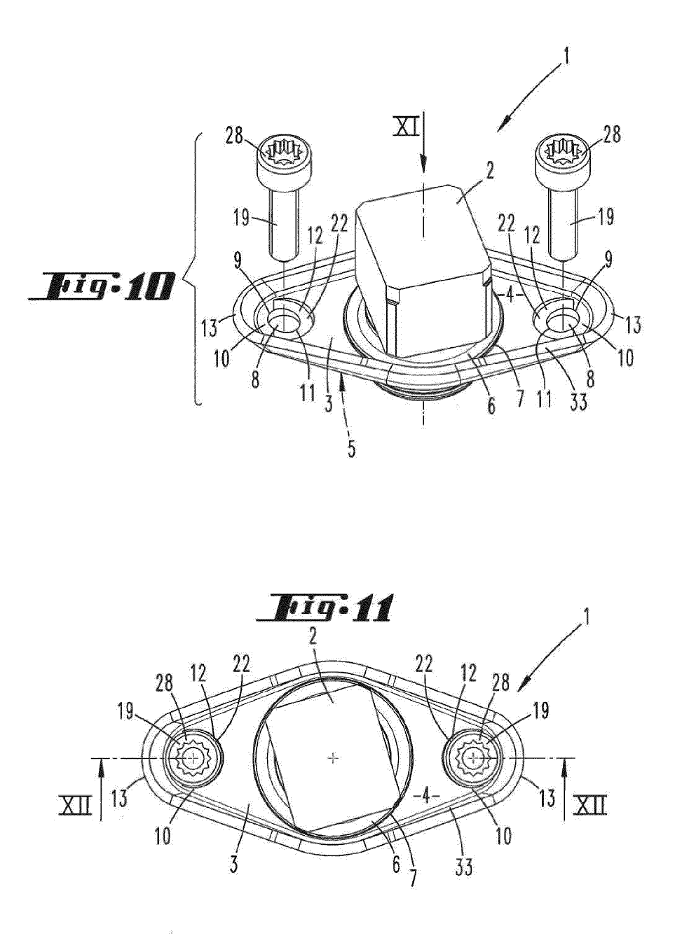

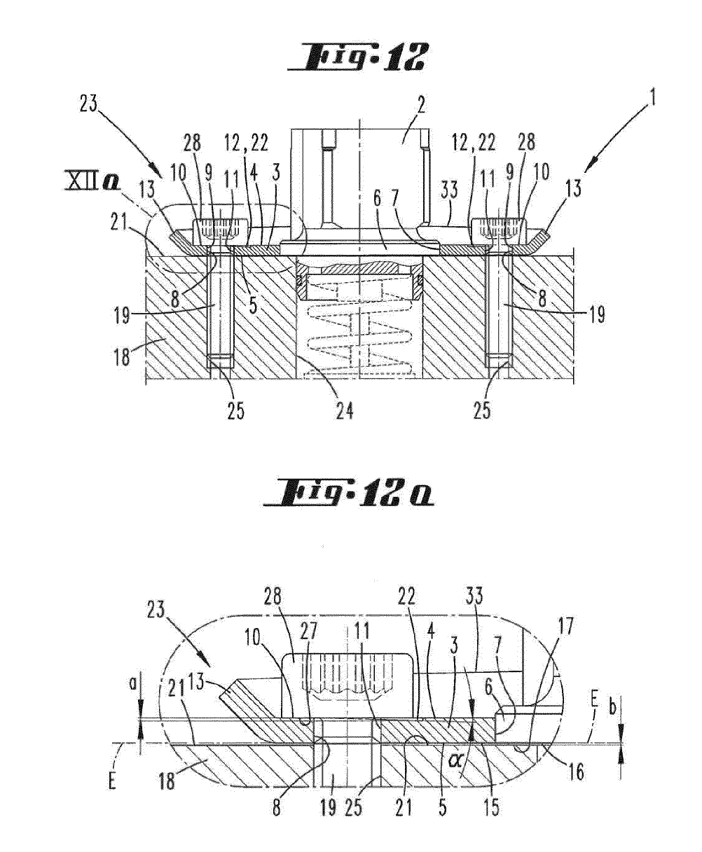

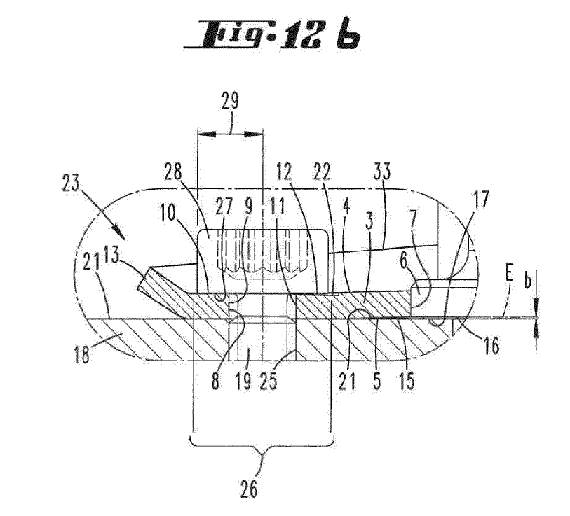

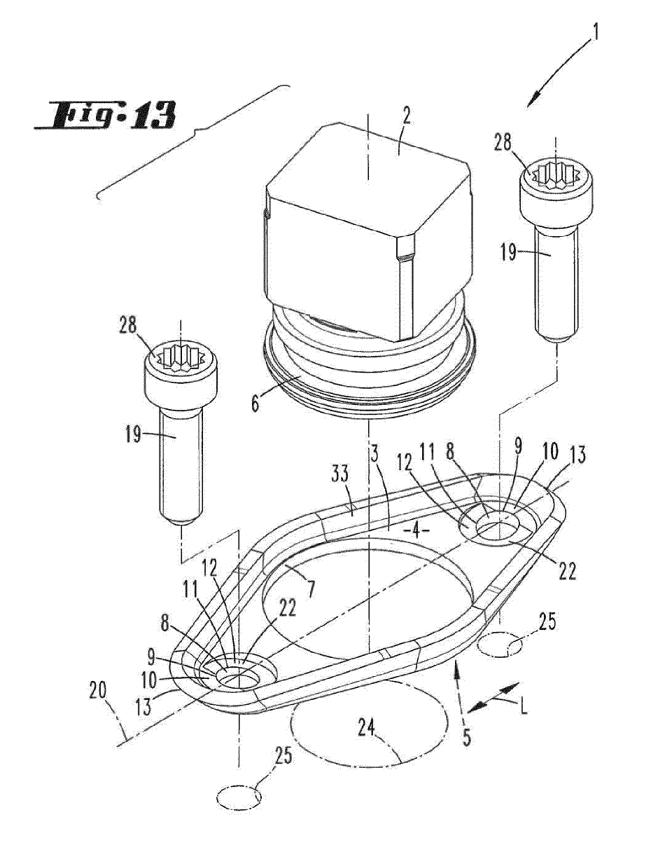

With reference to FIGS. 10 to 15, a combination 1 and an assembly 23 are described according to in each case a further preferred exemplary embodiment. As is the case in the preceding exemplary embodiments, the first flange surface region 10 extends so as to be parallel with the geometric reference plane E. The second flange surface region 12 is planar but, deviating from the preceding exemplary embodiments, extends so as to be inclined by an angle α in relation to the geometric reference plane E. The angle α shown in FIG. 12a is chosen such that the spacing of the second flange surface region 12 from the reference plane E in a direction perpendicular to the latter, when viewed in a direction parallel with the direction of longitudinal extent L, decreases as the spacing from the connector opening 7 decreases. In other words, the second flange surface region 12 slopes away from the first flange surface region 10 as the spacing increases. In the example, a peripheral portion of the outer periphery of the second flange surface region 12 runs along a circular line. The second flange surface region 12 overall thus has a crescent-shaped contour. As is the case in the preceding exemplary embodiments, in the non-stressed state the surface of the flange 3 on the second flange side 5 between the connector opening 7 and the assembly openings 8 extends so as to be parallel with the reference plane E.

With reference to the assembly 23 shown in FIG. 12, said assembly 23 comprising the combination 1, also shown in FIGS. 10, 11, the housing 18, and two screws 19 serving for the assembly, FIG. 12a shows an assembled state prior to the screws 19 being tightened, while FIG. 12b for comparison shows the completed assembly state after the two screws 19 have been tightened. Like the preceding figures, these illustrations are also schematic. The dimension a, while taking into consideration the inclination, corresponds to the largest quantitative difference that arises between the spacings of the flange surface regions 10, 12 from the reference plane E in the region of the screw head 28, said dimension a being chosen so as to be slightly smaller than the dimension b which corresponds to the gap width in the non-deformed initial state.

The angle α, or the dimension a, respectively, can be chosen such that as a result of the deformation of the flange in the completely screw-fitted state (cf. FIG. 12b) an ideally complete bearing of the screw head 28 on the flange 3 can be achieved. The lowest seating stress in this instance is created at the outermost periphery of the screw head on that side that faces the housing 2, where the depth of the depression 22 below the screw head 28 is the largest. While FIG. 12b for the sake of clarity shows a bearing of the screw head 28 that is not quite complete, a complete bearing could however be achieved in that the angle α or the dimension a, respectively, were to be chosen so as to be somewhat smaller.

In the case of the situation shown in FIG. 12b, a targeted partial (incomplete) de-stressing of the screw head 28 on that side facing the housing can be maintained by way of the clearance, so as to generate a maximum bracing force of the screw. Dimensions a, b (or angle α, respectively) that suit the respective application can be determined, for example, by simulations or by experiments, wherein tolerances emanating from the production of parts, as well as the rigidity values of further participating components, can also be taken into account. It can also be taken into account herein that the flange 3 on account of the depressions 22 in the region of the second flange surface region 12 becomes more flexible and adapts more easily at these locations, on account of which a further de-stressing of the screw head 28 can take place.

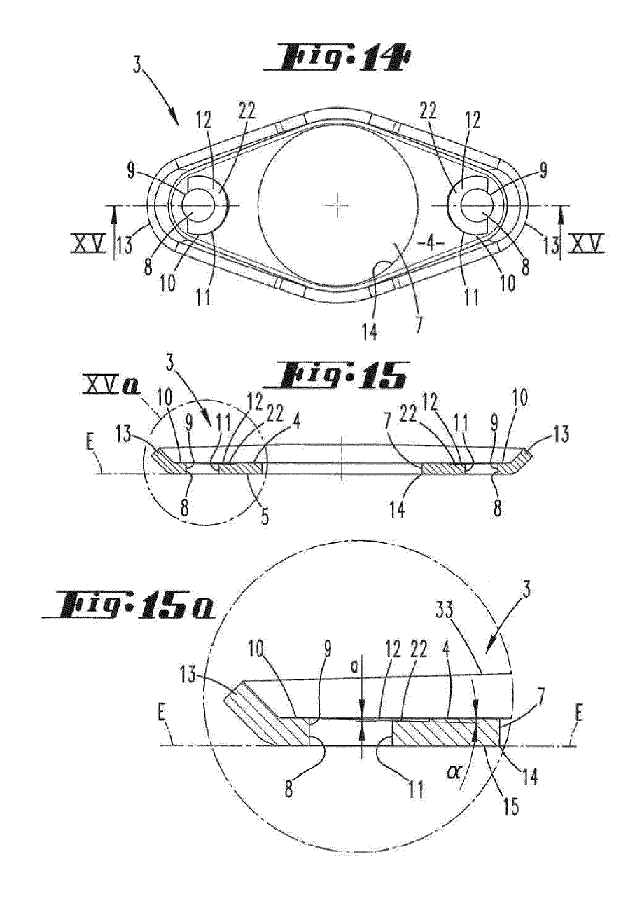

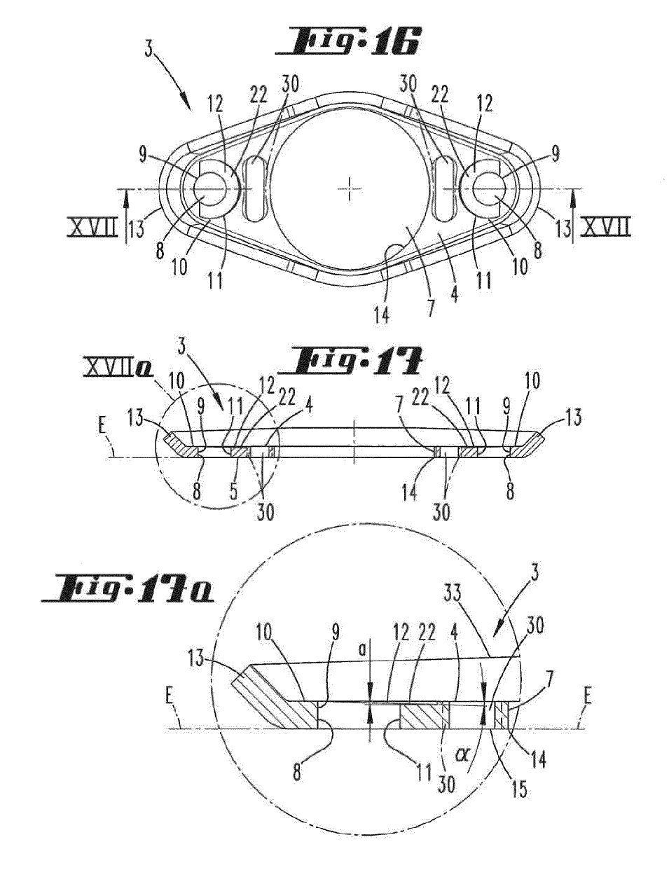

FIGS. 16, 17 and 17a show a flange 3 for a combination 1 incorporating teachings of the present disclosure. The difference in relation to the preceding exemplary embodiment is that in each case one clearance 30 that continues completely through the flange 3 is configured between the connector opening 7 and in each case one assembly opening 8. The clearances 30 serve for distributing the contact pressure. A first potential contour of the clearances 30 herein is shown by way of a solid line. The contour in dashed lines shows an alternative possibility. A symmetrical design embodiment is chosen in terms of the connector opening 7 lying therebetween.

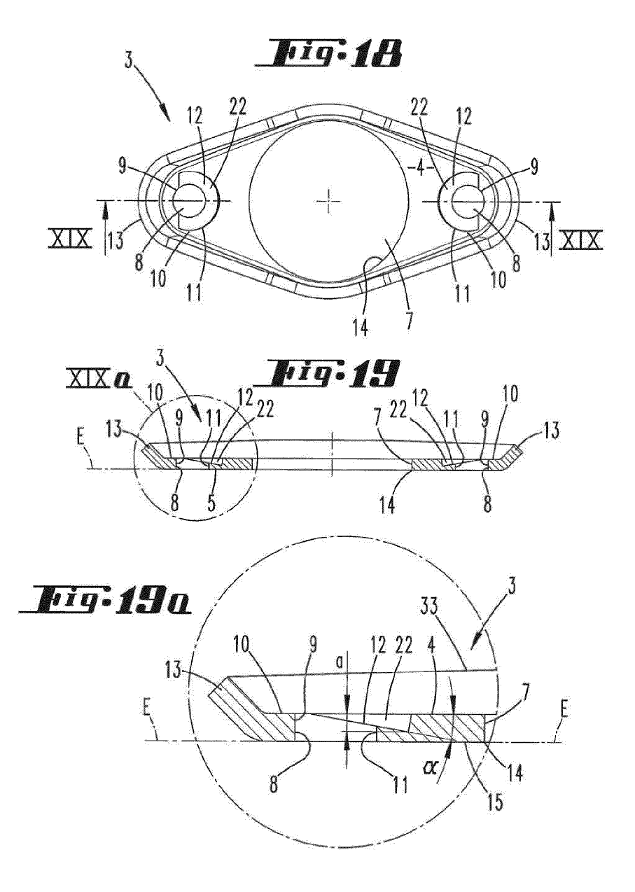

FIGS. 18, 19 and 19a show a further potential alternative design embodiment of the flange 3. The difference in relation to the preceding exemplary embodiment lies in that the angle α here has been chosen so as to be larger.

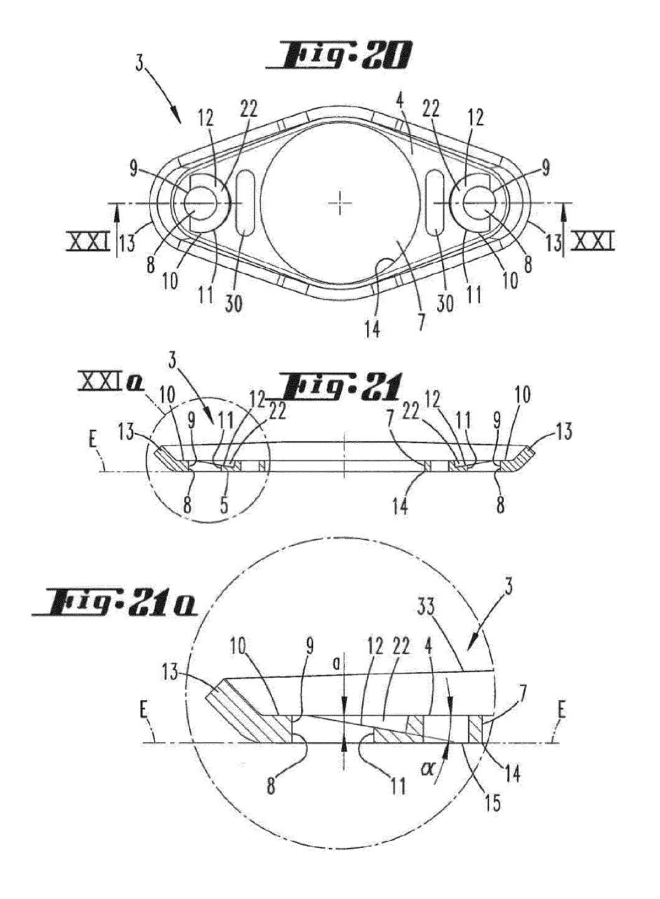

FIGS. 20, 21 and 21a show a yet further potential alternative design embodiment of the flange 3. Proceeding from the exemplary example shown in FIGS. 18, 19 and 19a, the two clearances 30 are additionally configured in said FIGS. 20, 21 and 21a. A reinforcement periphery which encircles the flange 3 and extends in a curved manner in a direction that leads away from the reference plane E is identified by the reference sign 33 in the case of the previously described exemplary embodiments.

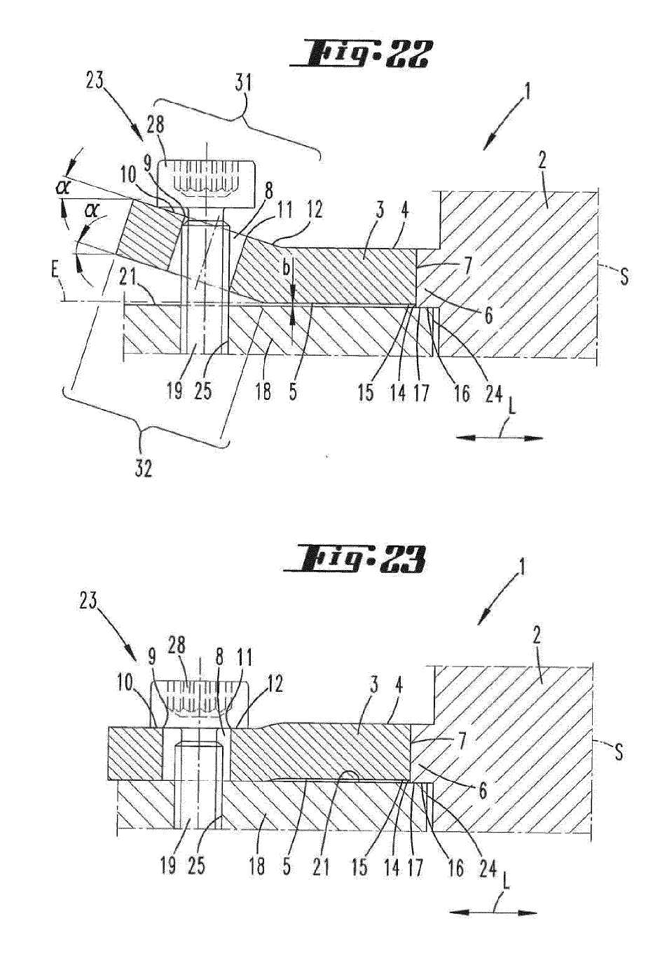

FIG. 22 by means of a sectional view schematically shows a fragment of a further exemplary embodiment of an assembly 23 incorporating teachings of the present disclosure, which comprises a combination 1, a housing 18, and screws 19 for the assembly. The housing 2 is the housing 2 of a single-piston pump. The housing 18 is the housing 18 of a cylinder head on an engine. FIG. 22 relates to a non-deformed initial state. The first flange surface region 10 and the second flange surface region 12 are component parts of a planar flange surface portion 31 that is oriented so as to be inclined at an angle α to the geometric reference plane E.

A second flange surface portion 32 which is contiguous to the same assembly opening 8 and surrounds the latter extends on the second flange side 5, said second flange surface portion 32 being oriented so as to be parallel with the first flange surface portion 31. The spacing of the first flange surface region 10 from the reference plane E in a direction perpendicular to the latter is also in the case of this exemplary embodiment larger than the spacing of the second flange surface region 12 from the reference plane E in a direction perpendicular to the latter. FIG. 22 shows a state prior to the screw 19 being tightened. There is the possibility for a symmetrical design embodiment to be present in terms of the line S lying at the right image periphery, such that the flange 3 is to be screw-fitted to the housing 18 by means of two screws 19.

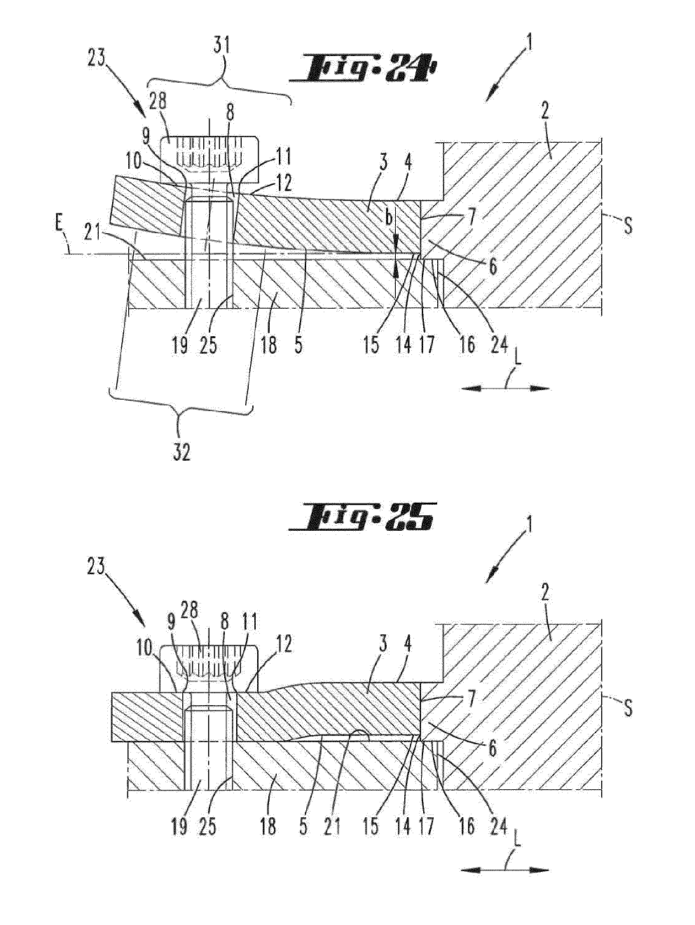

FIG. 23 schematically shows the state after the screw 19, or the screws 19, respectively, has/have been tightened. As is the case in the preceding exemplary embodiments, the gap (cf. the dimension b in FIG. 22) that is initially present when the screws 19 are tightened forms a pre-tensioning distance which enables an axial pre-tensioning force which is applied by the resilient flange (principle of a bending beam). The concept also in the case of this embodiment lies in offering up the angular error that is created on account of flexing of the flange already in the non-stressed flange (cf. FIG. 22) such that a parallel bearing of the screw head is created in the completely assembled state (cf. FIG. 23).

It is understood that the illustrations in FIG. 22 et seq. are to be understood as being only schematic, such that the angle α and further dimensions can also be chosen so as to deviate from the figures. In particular, an angle α that is chosen so as to be smaller in comparison to the figures may be expedient. The flexing profile in FIG. 23 is also illustrated in only a schematic manner and can deviate from the geometry shown. The angle α can be chosen so as to correspond to an angle that results in the flexing such that an approximately parallel bearing of the screw head in relation to the fastening surface 21 of the housing 18 (for example of a cylinder head housing) is created in the pre-tensioned state. The flange 3 can either be configured as a dedicated component or be integrated directly in the housing 2 (for example forged or molded on the latter, or the like). There is also the possibility for the flange 3 to be welded to the housing 2, for example, or else as a pure pre-tensioning element to bear on a bead on the housing, for example.

A further exemplary embodiment of an assembly 23, which comprises a combination 1 incorporating teachings of the present disclosure, is shown in FIG. 24. Some embodiments may be symmetrical in relation to the line S. FIG. 24 shows an assembled state prior to the screws 19 being tightened. In this non-stressed and non-deformed initial state of the flange 3, the first flange surface region 10 and the second flange surface region 12 are component parts of a flange surface portion 31 that is curved in a concave manner, the spacing of said flange surface portion 31 from the reference plane E, when viewed in a direction parallel with the direction of longitudinal extent L, increasing as the spacing from the connector opening 7 increases.

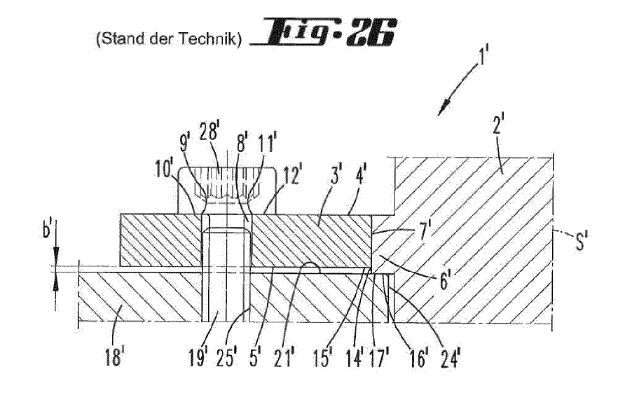

A further flange surface portion 32 which is contiguous to the same assembly opening 8 and surrounds the latter extends on the second flange side 5, said further flange surface portion 32 being oriented so as to be parallel with the first flange surface portion 31. The flange 3 in relation to the second flange side 5 (thus the flange side 5 facing the housing 18) is configured so as to be convex on the surface. The convex curvature can be chosen so as to correspond to the flexing line. There is the possibility for the flexing line to be approximated by means of a plurality of angles or radii. Also in the case of this embodiment, the braced assembled state of the latter being schematically shown in FIG. 25, an approximately parallel bearing of the screw head in relation to the fastening surface 21 of the housing 18 is achieved in the braced state. While an offset (cf. dimension b) between the flange 3 and the housing 18 can be required depending on the configuration in the non-stressed state in the case of the exemplary embodiment shown in FIGS. 22, 23, said offset can be dispensed with in the case of the example shown in FIGS. 24, 25.

What is claimed is:

1. An assembly comprising:
a housing;
a flange having a first flange side and opposite thereto a second flange side;
a collar either part of the housing or fastened to the housing, the collar extending into a connector opening of the flange;
wherein the flange includes a first assembly opening remote from the connector opening;
the first assembly opening having a first peripheral portion contiguous with a first flange surface region on the first flange side and a second peripheral portion contiguous to a second flange surface region and closer to the connector opening than the first peripheral portion;
wherein a periphery of the connector opening on the second flange side and/or a surface region of the flange adjacent to the connector opening defines a geometric reference plane; and
the first flange surface region is more remote in comparison to the second flange surface region in a direction perpendicular to the reference plane.

2. The assembly as claimed in claim 1, wherein:
the flange includes a second assembly opening remote from the connector opening;
the connector opening is disposed between the first assembly opening and the second assembly opening;
the second assembly opening includes a first peripheral portion contiguous to a first flange surface region on the first flange side: and
a second peripheral portion lies closer to the connector opening in comparison to the first peripheral portion of said second assembly opening; and
the first flange surface region contiguous to the first peripheral portion of the second assembly opening is more remote in comparison to the second flange surface region contiguous to the second peripheral portion of the second assembly opening in a direction perpendicular to the reference plane.

3. The assembly as claimed in claim 2, wherein:
the connector opening is centered between the first assembly opening and the second assembly opening; and
respective longitudinal central axes of the connector opening, the first assembly opening, and the second assembly opening collectively intersect a geometric longitudinal center line.

4. The assembly as claimed in claim 1, wherein:
the collar extends into the connector opening and a collar longitudinal end of the collar on the second flange side projects beyond the reference plane from the connector opening in a direction perpendicular to the reference plane.

5. The assembly as claimed in claim 1, wherein the collar is press-fit into the connector opening and/or is welded to the flange.

6. The assembly as claimed in claim 1, wherein:
a quantitative difference between a first spacing of the first flange surface region from the reference plane in a direction normal to the reference plane and second spacing of the second flange surface region from the reference plane in a direction normal to the reference plane is smaller than or equal to a third spacing of an end face of the collar longitudinal end and the reference plane in a direction normal to the reference plane.

7. The assembly as claimed in claim 1, wherein the housing houses a single-piston pump or a servo valve.

8. The assembly as claimed in claim 1, wherein the first flange surface region and the second flange surface region extend parallel to the geometric reference plane.

9. The assembly as claimed in claim 1, wherein the second flange surface region comprises a base face of a quadrangular-bordered depression in the flange on the first flange side.

10. The assembly as claimed in claim 1, wherein:
the first flange surface region extends parallel to or inclined to the geometric reference plane;
the second flange surface region extends inclined to the geometric reference plane;
a spacing of the second flange surface region from the reference plane in a normal to the reference plane, when viewed in a direction parallel to longitudinal extent, decreases as the spacing from the connector opening decreases; and
a peripheral portion of an outer periphery of the second flange surface region runs along a circle.

11. The assembly as claimed in claim 1, wherein a surface of the flange on the second flange side, at least between the connector opening and the assembly opening, extends parallel to the reference plane.

12. The assembly as claimed in claim 1, wherein:
the first flange surface region and the second flange surface region comprise component parts of a planar first flange surface portion inclined in relation to the geometric reference plane; and
on the second flange side a second flange surface portion contiguous to and surrounding the assembly opening extends parallel to or substantially parallel to the first flange surface portion.

13. The assembly as claimed in claim 1, wherein:
the first flange surface region and the second flange surface region comprise component parts of a first flange surface portion curved;
a local inclination of the first flange surface portion relative to the reference plane when viewed in a direction parallel with the direction of longitudinal extent increasing as a distance from the connector opening increases; and
on the second flange side a second flange surface portion contiguous to and surrounding the assembly opening extends parallel to or substantially parallel to the first flange surface portion.

14. The assembly as claimed in claim 1, wherein the flange comprises one clearance between the connector opening and each assembly opening.

15. An assembly comprising:
a housing with a planar fastening surface;
a flange having a first flange side and opposite thereto a second flange side;
a collar either part of the housing or fastened to the housing, the collar extending into a connector opening of the flange;
wherein the flange includes a first assembly opening remote from the connector opening;
the first assembly opening having a first peripheral portion contiguous with a first flange surface region on the first flange side and a second peripheral portion contiguous to a second flange surface region and closer to the connector opening than the first peripheral portion;
wherein a periphery of the connector opening on the second flange side and/or a surface region of the flange adjacent to the connector opening defines a geometric reference plane; and
the first flange surface region is more remote in comparison to the second flange surface region in a direction perpendicular to the reference plane;
wherein, proceeding from the fastening surface, an insertion opening and a first assembly bore extend into the housing;
a collar longitudinal end is supported on a region of the fastening surface adjacent to the insertion opening;
a screw extends through the first assembly opening and the first assembly bore;
the flange is connected to the housing by the screw; and
the screw is tightened such that a first flange region in which the first assembly opening is configured contacts the fastening surface and is compressed against the latter.

16. The assembly as claimed in claim 15, wherein:
proceeding from the fastening surface, at least one second assembly bore extends into the housing;
a second screw extends through the second assembly opening and the second assembly bore;
the flange is connected to the housing by the second screw; and
the second screw is tightened such that a second flange region of the second assembly opening contacts the fastening surface and is compressed against the latter.

17. The assembly as claimed in claim 16, wherein that the first screw and the second screw have in each case one screw head having a respective bearing region with the flange lying completely in a respective surface region of the flange formed collectively by a first flange surface region and a second flange surface region.

18. The assembly as claimed in claim 15, wherein the housing protrudes into the insertion opening.
